(19) United States
(12) Patent Application Publication
(10) Pub. No.: US 2005/0047405 A1
(43) Pub. Date: Mar. 3, 2005

(54) Switching device for controlling data packet flow

(75) Inventors: Wolfgang E. Denzel, Langnau am Albis (CH); Ilias Iliadis, Rueschlikon (CH)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/923,238

(22) Filed: Aug. 20, 2004

(30) Foreign Application Priority Data
Aug. 25, 2003 (EP) 03405616.8

(51) Int. Cl. H04L 12/28

(52) U.S. Cl. 370/388

(57) ABSTRACT

Methods for controlling a data packet flow through a switch having first, second and third stage switch modules. Each switch module has a number of data inputs, a number of data outputs, and a data packet buffer. The data outputs of the first stage switch modules are connected to data inputs of the second stage switch modules, and data outputs of the second stage switch modules are connected to the data inputs of the third stage switch modules. A data packet received at one of the first stage switch modules is forwarded to a specific data output of one of the third stage switch modules. A method for controlling a data packet flow comprises: A storing credit information associated to each of the second stage switch modules indicating a number of free data packet buffer locations in the respective second stage switch module; selecting one of the second stage switch modules in dependence on the credit information; forwarding the received data packet from the first stage switch module to the selected second stage switch module; forwarding the received data packet from the selected second stage switch module to the respective third stage switch module, from which the received data packet is to be sent; after sending the data packet from the respective third stage switch module, delivering a credit information about the freed data packet buffer location from the third stage switch module to the second stage switch module, wherein the respective second stage switch module is chosen by a credit return strategy.

### FIELD OF THE INVENTION

The present invention relates to a method for controlling a data packet flow through a switching device having multiple switch module stages. The present invention further relates to a switching device for controlling a data packet flow.

### BACKGROUND OF THE INVENTION

A multi-stage architecture is the choice for obtaining large-scale communication switches with high bandwidths and a large number of input/output ports. Among multi-stage arrangements, multi-path topologies are preferable for performance reasons. Multi-path topologies provide multiple paths between any input/output pair of the communication switch. Generally, multi-path switches require that the traffic is evenly spread across all available paths, a function in the following referred to as load balancing. In the case of packet switching, a load balancing mechanism provides a dispatching of the arriving data packets to different paths.

In order to provide a multi-path environment, several stages of switch modules are arranged. The first (input) stage of the switch modules having data input serves as the input node where the data paths diverge and are connected to second-stage switch modules to where the data packets are transmitted. From the second-stage switch modules the data packets are transmitted to third-stage switch modules representing output nodes where the data paths merge again.

Various static or dynamic, cyclic or switch state dependent mechanisms for assigning data packets to paths are known. The most efficient mechanisms are dynamic, i.e. the path assignment for each packet is treated independently. This causes packets of a given flow to traverse differently loaded buffers on different paths. As a result, data packets may arrive at the end node in a order different from the one in which they originally entered the system. As FIFO delivery (First-In-First-Out) is required, out-of-sequence-packets must wait at the output node to be put back into proper sequence. This requires packet re-sequencing functions at the output nodes, the cost of which is considered to be reasonable for the performance gain that such dynamic load balancing mechanisms provide. However, if the re-sequencing buffer resources are not dimensioned for the worst case out-of-sequence-scenario, deadlocks may occur. Hence, the art is to minimize and/or to limit the number of out-of-sequence-packets and thereby minimize size and costs of the re-sequencing buffers. This in turn requires the minimization of load asymmetries between the paths.

Most prior art multi-path packet switches are ATM switches which normally do not need to be strictly lossless and hence do not typically have a flow control scheme. In such switches without flow control capability, the goal to minimize load asymmetry between the paths is achieved reasonably by most known load balancing mechanisms. This is no longer the case if a flow controlling scheme is used in order to ensure a lossless operation. The flow control is typically realized by means of a backpressure mechanism. If there is a temporary overload at a specific destination also referred to as a hot spot, backpressure is generated and causes packets destined for the hot spot destination to wait in the previous stages which also increases the load for the previous stages.

It is noticed that backpressure may adversely interfere with a load balancing function because it can temporarily disturb the load symmetry imposed by the load balancing mechanism among the paths. For example, this may happen if data packets stop arriving such that no data packet can be used to fill a less loaded path to a level similar to other paths. Furthermore, the path-joining function at the output nodes might also not be able to react in the case of backpressure, if it is based on a typical rigid multiplexing scheme that handles all paths equally. In any case, the load asymmetries due to backpressure cause higher delay, jitter and higher out-of-sequence which in turn requires more re-sequencing buffer resources and hence higher cost.

Furthermore, a problem exists if multiple priorities must be supported which is also the case in modern packet switches and routers with QOS support (quality of service). If a path is highly loaded with strictly preemptive high priority traffic, lower priority data packets may be blocked in a switch buffer as well is in the re-sequencing buffer. Other priority data packets may still proceed through other data paths and load the re-sequencing buffer. This buffer can no longer be emptied since missing data packets in the sequence may still be blocked in the switch buffer of the path overloaded by high priority traffic. As a consequence, preemptive priorities can cause a large worst-case resource requirement for the re-sequencing buffer which is desirable to be minimized as well.

### SUMMARY OF THE INVENTION

It is therefore an aspect of the present invention to provide methods and switching devices to overcome the problems caused by the backpressure which may be produced by known load balancing mechanisms, and to minimize load asymmetries between the data paths. It is furthermore an aspect of the present invention to overcome the problem provided by preemptive priorities which require large worst-case resources in the switching devices.

These and other aspects of the present invention are overcome by a method for controlling a data packet flow through a switching device, a first stage switch module, a third stage switch module, a switching module and a switching device. The present invention provides a method for controlling a data packet flow through a switching device is provided.

The method of the present invention combines a method of forwarding a data packet to a selected second-stage switch module, which is referred to as a credit-based load balancing mechanism, and a method of returning the credit information to one of the second-stage switch modules, which is referred to as a credit return mechanism. The credit information stored in each of the second-stage switch modules is used to select the respective second-stage switch module to which any of the received data packet is forwarded to. By combining the load dependent load balancing mechanism based on a credit flow control between the second stage and the first stage and the credit base flow control scheme between the third stage and the second stage, a minimizing of load asymmetry is achieved.

According to another aspect of the present invention, a first-stage switch module of a three- or more-stage switching device is provided. The first-stage switch module has a number of data inputs, a number of data outputs to be connected to second-stage switch modules, a data packet buffer to receive and to store externally received data packets. The first-stage switch module further includes a credit memory to store credit information for each of the second stage switch modules, wherein the credit memory is operable to receive an information on a freed data packet buffer location in one of the second stage switch modules. Furthermore, a packet scheduling means is provided to select (schedule) a next data packet for transmission from the data packet buffer and to select the data output on which the selected (scheduled) data packet is to be sent, depending on the stored credit information of each of the second-stage switch modules connected to the data outputs. A credit insertion means is provided to insert one or more credits in a data packet to be sent to a chosen second-stage switch module associated with a respective data output to return the one or more credits to the chosen second stage switch module wherein the second-stage switch module is chosen by the packet scheduling means according to an appropriate credit return strategy.

A first-stage switch module according to the present invention has the advantage that is can perform the load balancing mechanism which is credit based as well as support the credit return strategy wherein a credit information on a freed data packet buffer location in one of the second-stage switch modules is returned to the chosen second-stage switch module.

According to another aspect of the present invention, a third-stage switch module is provided comprising a number of data inputs to be connected to second-stage switch modules, a number of data outputs and a data packet buffer to receive and to store data packets from the second-stage switch modules. The third-stage switch module further comprises a credit extraction means to extract first credit information sent by the second-stage switch modules and to provide the respective credit information used for a path selecting function which is operable to select a path for a data packet between a first-stage switch module and a second-stage switch module. The third-stage switch module further comprises a packet scheduling means to select (schedule) a next data packet for transmission from the data packet buffer and to send the selected (scheduled) data packets to the respective data output in a given order and according to their destination and to return a second credit information to one of the second-stage switch modules.

According to another aspect of the present invention, a switching device for controlling a data packet flow is provided. The switching device comprises a first number of first-stage switch modules, a second number of second-stage switch modules, wherein the second number is bigger than the first number and a third number of third-stage switch modules wherein each of the first, second and third-stage switch modules has a number of data inputs, a number of data outputs and a data packet buffer wherein the data outputs of the first-stage switch modules are at least partially connected to the data inputs of the second-stage switch modules. The data outputs of the second-stage switch modules are at least partially connected to the data inputs of the third-stage switch modules. The data packets received at the data input of one of the first-stage switch modules is forwarded to the specific data output of one of the third-stage switch modules. The respective first credit information used for a path selecting function is provided to the credit memory of the first-stage switch module to be stored. The respective second credit information is provided to the credit insertion means to insert into the data packet the second credit information of one or more credits to be sent to a chosen second-stage switch module associated with a respective data output to return the one or more credits to the chosen second-stage switch module according to the appropriate credit return strategy.

### BRIEF DESCRIPTION OF THE DRAWINGS

For a more complete understanding of the present invention and the advantages there of, reference is now made to the following description taken in conjunction with the accompanying drawings, in which:

FIG. 1 shows a general architecture of a switching device for forwarding a data packet from an input to an output node;

FIG. 2 shows a relative amount of queuing per port of the switching device depending on the number of second-stage switch modules;

FIG. 3 represents the credit-based load balancing mechanism including the data path selecting function;

FIG. 4 shows the credit return strategy according to the present invention; and

FIG. 5 shows a switching device according to a preferred embodiment of the present invention.

### DETAILED DESCRIPTION OF THE INVENTION

The present invention provides methods, systems and switching devices to overcome problems caused by backpressure which may be produced by known load balancing mechanisms and to minimize load asymmetries between the data paths. The present invention overcomes the problem due to preemptive priorities which requires large worst-case resources in the switching devices.

In an example embodiment, a method for controlling a data packet flow through the switching device includes, a first stage switch module, a third stage switch module a switching module and a switching device.

Advantageous embodiments of the present invention are described by the subject matter of the dependent claims. Thus, the present invention provides a method for controlling a data packet flow through a switching device is provided. The switching device has a first number of first-stage switch modules, a second number of second-stage switch modules and a third number of third-stage switch modules, wherein each of the switch modules has a number of data inputs, a number of data outputs and a data packet buffer. The data outputs of the first stage switch modules are connected to the data inputs of the second-stage switch modules wherein the data outputs of the second-stage switch modules are connected to the data inputs of the third-stage switch modules. A data packet received at a data input of one of the first-stage switch modules is forwarded to a specific data output of one of the third-stage switch modules. In order to forward a data packet, the following steps are performed:

First a credit information associated with each of the second-stage switch modules indicating a number of free data packet buffer locations in the respective second-stage switch module are stored. Depending on the credit information, one of the second-stage switch modules is selected. The received data packet is forwarded from the first-stage switch module to the selected second-stage switch module. The received data packet is forwarded from the selected second-stage switch module to the respective third-stage switch module from which the received data packet is to be sent.

After sending the data packet from the respective third-stage switch module, a second (type of) credit information on the freed data packet buffer location from the third-stage switch module to the second-stage switch module is transmitted. To which of the second-stage switch modules the credit information is returned is chosen by an appropriate credit return strategy.

The method of the present invention combines on the one hand the method of forwarding a data packet to a selected second-stage switch module, which is referred to as a credit-based load balancing mechanism, and on the other hand the method of returning the credit information to one of the second-stage switch modules, which is referred to as a credit return mechanism. The credit information stored in each of the second-stage switch modules is used to select the respective second-stage switch module to which any of the received data packet is forwarded to. By combining the load dependent load balancing mechanism based on a credit flow control between the second stage and the first stage and the credit base flow control scheme between the third stage and the second stage, a minimizing of load asymmetry is achieved.

The credit information of the second-stage switch modules serve two purposes. The primary purpose is flow control. An available credit information allows a new packet to be sent to a data buffer that is associated with the credit information. The second purpose is load balancing. The number of available credits for a specific second-stage switch module represent the inverse load of the data path through this second-stage switch module and serves as load information for the load dependent load balancing mechanism.

If a data buffer in a certain second-stage switch module is overloaded due to backpressure, very few associated credits (or none) will be available in the first-stage switch module. The path through that second-stage switch module should preferably be avoided by the load-balancing mechanism of the next data packet unless all other paths are equally or even higher loaded. Specifically, the path selecting function of the load balancing mechanism assigns the next scheduled data packet to the path (second-stage switch module) for which the most credits are available in the second-stage switch module to which the scheduled data packet is destined.

According to the credit based flow control scheme between the third-stage switch modules and the second-stage switch modules, since most queuing happens in the third stage, most of the data buffer is required in third-stage switch modules. If the data buffer in the third-stage switch modules were to be segmented into portions dedicated to the paths, each path would be more likely to overflow than if the data buffer was shared among all paths. If a data packet leaves the respective output node, a credit information associated with the freed buffer location must be returned to one of the second-stage switch modules. As one credit can only be returned to one of the second-stage switch modules, a fair credit return mechanism is required. Therefore, according to the present invention, an appropriate credit return strategy is proposed. In contrast to the load balancing mechanisms, the credits could be returned to the second-stage switch modules (data paths) with the fewest credits available for the switch buffers associated with the destination from which the credit comes. By using the credit return strategy together with the credit-based flow control and data path selecting scheme, an advantageous method for data packet flow control is provided because load asymmetry and the likelihood of the occurrence of deadlocks due to backpressure is reduced.

Advantageously, one of the second-stage switch modules is selected having the most free data packet buffer locations. If there is more than one of the second-stage switch modules having the same number of free data path buffer locations, the one second-stage switch module is selected randomly or according to a round-robin scheme. This is in order to avoid undesirable synchronization effects at high load. It can be provided that according to the credit return strategy the credit is returned by increasing the number of credits, i.e. the number of free data packet buffer locations in the respective second-stage switch module. The respective second-stage switch module is chosen by a round-robin scheme, by a random or by the second-stage switch module having the lowest number of free data packet buffer locations.

Advantageously, the delivering of credit information on the freed data packet buffer locations from the third-stage switch module to the second-stage switch module includes the transmission of the credit information from the third-stage switch module to the first-stage switch module. The credit information is added to the next data packet to be transmitted to the chosen second-stage switch module and then the next data packet is transmitted to the chosen second-stage switch module. As the connections between the first-stage switch modules and the second-stage switch modules as well as the connections between the second-stage switch modules to the third-stage switch modules are substantially unidirectional, a credit information normally cannot be transmitted from the third-stage switch module to the chosen second-stage switch module. Thus, it is provided to transmit the credit information firstly to one of the first-stage switch modules which is assigned to the respective third-stage switch module, for example if the first-stage switch module and the third-stage switch module are integrated in one single device. If a data packet is to be transmitted to the chosen second-stage switch module according to the appropriate credit return strategy, the credit information is added to the respective data packet and transmitted to the chosen second-stage switch module.

Advantageously, the data packets are forwarded according to a priority scheduling mechanism wherein the transmission of high priority data packets are preferred to transmission of lower priority data packets. The priority scheduling mechanism is overridden if the transmission of lower priority data packets is blocked for a predetermined time or if an override information is generated indicating that one or more of the lower priority data packets are preferably transmitted wherein the override information is generated depending on missing low-priority data packets in sequence of data packets in the data buffer of a third-stage switch module.

Thereby, the problem of the priority blocking as mentioned above is addressed. The requirement of a large re-sequencing buffer can be reduced as low-priority packets blocked for longer time in the data buffers of the second-stage switch modules or the first-stage switch modules get a chance to proceed to the third-stage switch modules where they may likely fill sequence gaps. This is achieved by the priority scheduling mechanism preferably performed in the second-stage switch modules which overrides the strict priority rules if low-priority packets are blocked for too long. This can be realized by taking into account the time a packet has spent in the queue or by any other priority adaptation mechanism. By introducing additional complexity, this might alternatively be initiated by an explicit request from the re-sequencing logic of the third-stage switch modules which is sent when a sequence gap either of large size or of lengthy time period has been detected.

The present invention, also provides a first-stage switch module of a three- or more-stage switching device. The first-stage switch module has a number of data inputs, a number of data outputs to be connected to second-stage switch modules, a data packet buffer to receive and to store externally received data packets. The first-stage switch module further includes a credit memory to store credit information for each of the second stage switch modules, wherein the credit memory is operable to receive an information on a freed data packet buffer location in one of the second stage switch modules. Furthermore, a packet scheduling means is provided to select (schedule) a next data packet for transmission from the data packet buffer and to select the data output on which the selected (scheduled) data packet is to be sent, depending on the stored credit information of each of the second-stage switch modules connected to the data outputs. A credit insertion means is provided to insert one or more credits in a data packet to be sent to a chosen second-stage switch module associated with a respective data output to return the one or more credits to the chosen second stage switch module wherein the second-stage switch module is chosen by the packet scheduling means according to an appropriate credit return strategy.

A first-stage switch module according to the present invention has the advantage that is can perform the load balancing mechanism which is credit based as well as support the credit return strategy wherein a credit information on a freed data packet buffer location in one of the second-stage switch modules is returned to the chosen second-stage switch module.

Also provided is a third-stage switch module comprising a number of data inputs to be connected to second-stage switch modules, a number of data outputs and a data packet buffer to receive and to store data packets from the second-stage switch modules. The third-stage switch module further comprises a credit extraction means to extract first credit information sent by the second-stage switch modules and to provide the respective credit information used for a path selecting function which is operable to select a path for a data packet between a first-stage switch module and a second-stage switch module. The third-stage switch module further comprises a packet scheduling means to select (schedule) a next data packet for transmission from the data packet buffer and to send the selected (scheduled) data packets to the respective data output in a given order and according to their destination and to return a second credit information to one of the second-stage switch modules.

The third-stage switch module according to the present invention supports the transmitting of the first credit information to a selected second-stage switch module according to the path selecting function and allows to perform a credit return strategy to return a credit information to one of the second-stage switch modules. By the combination of these two mechanisms, an advantageous switching device can be built, thereby reducing load asymmetries and preventing the emergence of hot spots.

Preferably, a switching module including a first-stage switch module according to the present invention and a third-stage switch module according to the present invention is provided. The first stage-switch module and the third-stage switch module are commonly integrated into one single device. Thereby, the transmission of the credit information from the third-stage switch module to the first-stage switch module can easily be implemented by a data channel integrated in one device.

The present invention further provides a switching device for controlling a data packet flow is provided. The switching device comprises a first number of first-stage switch modules, a second number of second-stage switch modules, wherein the second number is bigger than the first number and a third number of third-stage switch modules wherein each of the first, second and third-stage switch modules has a number of data inputs, a number of data outputs and a data packet buffer wherein the data outputs of the first-stage switch modules are at least partially connected to the data inputs of the second-stage switch modules. The data outputs of the second-stage switch modules are at least partially connected to the data inputs of the third-stage switch modules. The data packets received at the data input of one of the first-stage switch modules is forwarded to the specific data output of one of the third-stage switch modules. The respective first credit information used for a path selecting function is provided to the credit memory of the first-stage switch module to be stored. The respective second credit information is provided to the credit insertion means to insert into the data packet the second credit information of one or more credits to be sent to a chosen second-stage switch module associated with a respective data output to return the one or more credits to the chosen second-stage switch module according to the appropriate credit return strategy.

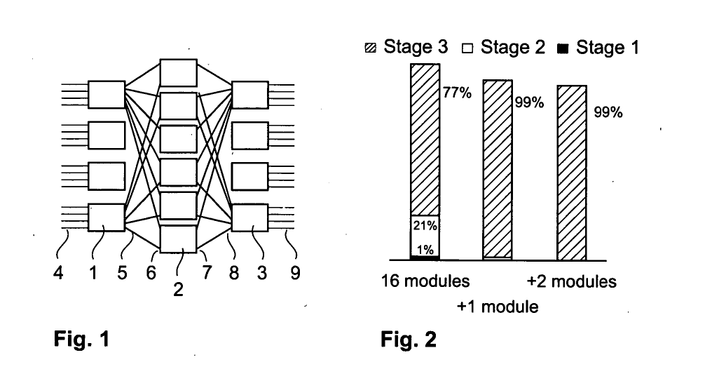

In FIG. 1, a preferred system topology is depicted having three stages of switch modules, first-stage switch modules 1, second-stage switch modules 2 and third-stage switch modules 3. Each of the first-stage switch modules 1 has a first number of first inputs 4 and a second number of first outputs 5 connected to second inputs 6 of each of the second stage switch modules 2.

The number of the second stage switch modules 2 is preferably chosen to be larger than the number of the first-stage switch modules and the number of the first-stage switch modules 1 substantially equals the number of the third-stage switch modules 3. By choosing a larger number of second-stage switch modules, less queuing in the middle second stage can be achieved and consequently less load asymmetry. This is illustrated in FIG. 2 wherein the queue occupancy is depicted for three different switching devices having 16 first-stage switch modules and including 16 second-stage switch modules, 17 second-stage switch modules and 18 second-stage switch modules, indicating that the queuing in the second stage and even in the first stage can be reduced to less than 1% by increasing the number of second-stage switch modules. By further increasing the number of second-stage switch modules, practically no more benefit can be realized.

The interconnection between the first stage switch modules 1 and the second-stage switch modules 2 are exemplary shown, i.e. not every possible and present interconnection is delicately depicted. The same is true for the interconnections between second outputs 7 of the second-stage switch modules 2 and third inputs 8 of the third-stage switch modules 3. Each of the third-stage switch module has a number of third outputs representing the output channels for the data packets. As normally a switching device has the same number of inputs and outputs, the same number of first second stage switch modules and third-stage switch modules having the same number of inputs and outputs, respectively, is preferred. Conventionally, one of the first-stage switch modules 1 is integrated in a single device together with a third-stage switch module, thereby providing inputs and outputs and interconnections to the respective second-stage switch modules 2.

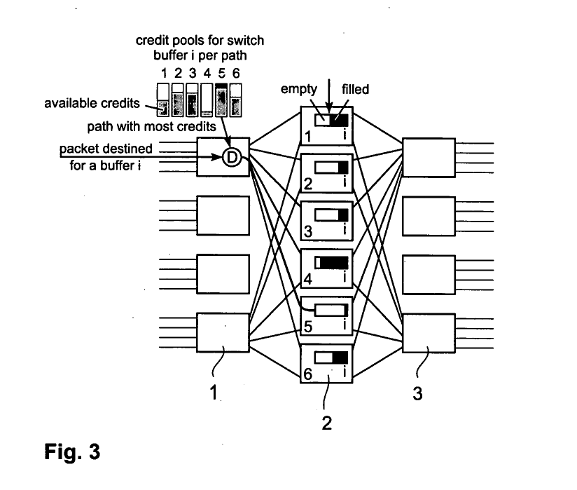

In FIG. 3, the method of the load dependent load balancing mechanism combined with a credit based flow control between the second-stage switch modules and the first-stage switch modules is illustrated. Each of the first-stage, second-stage and third-stage switch modules 1, 2, 3 has a data buffer with a specific predetermined size respectively. An information about the queue occupancy is provided indicating the number of data packets which are queued in the second-stage switch module, thereby indicating the number of free data packet buffer locations. The mechanism is based on credits provided by the data buffer of the second-stage switch module and stored in a credit memory in the first-stage switch modules wherein each credit stored in the credit memory indicates a free data packet buffer location in which a data packet can be stored. From the credit memory, the credit information is generated indicating the load of the data buffer, i.e. the load of the respective data path and thereby the credits representing the inverse load of the respective data paths through this data buffer.

Thus, the credit information is derived from the second-stage data buffer filling state and is provided to at least one of the first-stage switch modules. As the credit information of the second-stage switch modules 2 are transferred to the first-stage switch modules without any request, the credit information is preferably sent to each of the first-stage switch modules 1 continuously so that each of the first-stage switch modules 1 has an updated information on the filling state of the credit memory in each of the second-stage switch modules 2 at any time. If the data packet arrives through one of the first inputs 4 of one of the first-stage switch modules 1, the first-stage switch module 1 decides according to the available credits stored in the credits memory in each of the second-stage switch modules 2 to which of the second-stage switch module 2 the respective data packet is forwarded. Generally, an available credit allows a new packet to be sent to the data buffer of the respective switch module that is associated with the credit.

According to the load balancing mechanism of the present invention, the received data packet is forwarded to the second-stage switch module which has the most available credits left. If a data buffer in a certain second-stage switch module is overloaded due to backpressure, very few associated credits for the second-stage switch module will be available in the first-stage switch module. According to the method of forwarding the data packet, the data path through that second-stage switch module should preferably be avoided by the load balancing mechanism for the next one or more data packets, unless all other paths are equally or even higher loaded.

In the shown example of FIG. 3, the data packet which is scheduled next would be transferred to the second-stage switch module indicated by number “5” because in this second-stage switch module 2 the most free data buffer locations are left.

In case the same number of credits is available for multiple paths, it is important that the choice for one of them is of quasi-random nature (e.g. using a round-robin scheme) in order to avoid undesirable synchronization effects at high load. When a path is selected it is marked as allocated. As long as there are more packets waiting in the first stage of the switching device and not all paths are already allocated, the selecting of the data paths is repeated within the same data packet cycle thereby excluding the already occupied data paths in the search.

The way the credit information in the second-stage switch module 2 is transferred to the first-stage switch module 1 can be direct or can be performed by using a data packet transmitting from the second-stage switch module from which the credit information is to be transmitted to the destined third-stage switch module. Therefore, the credit information is then preferably added to e.g. the header of a data packet destined to the third-stage switch module 3 and is extracted from the respective data packet in the third-stage switch module 3 and then transferred to the first-stage switch module 1 by a data line between the first-stage switch modules 1 and the third-stage switch modules 3. As one or more of the first-stage switch modules 1 are integrated together with one or more third-stage switch modules in a single device, the data line from the third-stage switch module 3 to the first-stage switch module is much easier to implement than a data line between the second-stage switch module 2 and the first-stage switch module 1, as these are typically not integrated into one single device.

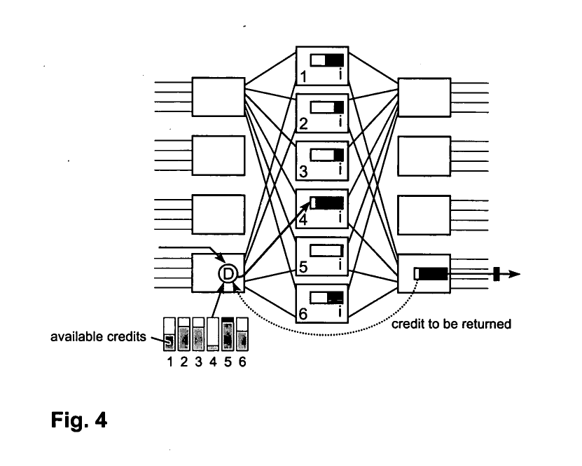

In FIG. 4 a credit return strategy is depicted. Since most queuing happens in the third-stage switch modules due to the providing of a bigger number of second-stage switch modules, most of the data buffer space required is needed there. In order to avoid an overflow of the data buffer in each of the third-stage switch modules, the data buffer space is not segmented into parts dedicated to the data paths. So the third data buffer included in the third-stage switch modules 1 is shared among all data paths.

If a data packet is being transmitted through a third output of the third-stage switch buffer, a credit associated with the freed data buffer location must be returned to the second stage of the switching device. As explained above, to avoid an additional data line between the second-stage switch module 2 and the third-stage switch module, this is done via the first stage counterpart of the considered third-stage switch module 3 in a common integration of one or more of the first-stage switch modules 1 and one or more of associated third-stage switch modules 3. As one credit can only be returned to one respective second-stage switch module 2 through its corresponding data path, a fair credit return strategy is required. A suitable credit return strategy could be a round-robin, another return strategy could be load-dependent. In contrast to the load balancing mechanism as explained above, the credits could be returned to the data paths, i.e. the second-stage switch module 2 representing a data path, with the fewest credits available for the second-stage switch module 2 buffers associated with the destination from which the credit is coming. Also, in case the same number of credits is available from multiple paths, it is important that the choice for one of them is (quasi-) random in order to avoid undesirable synchronization effects at high load.

In the example shown in FIG. 4, the credit originated from a freed buffer location by sending the data packet via the outputs of the third-stage switch module 3 are to be returned to the second-stage switch module 2 having the number 4, since there is the smallest number of available credit left compared to each of the second-stage switch modules 2. The returning of the credit is done via the first-stage switch module associated to the third-stage switch module 3 from which the data packet is transmitted via the respective third output. The credit information is returned on a data line provided between the first-stage switch module 1 and the associated third-stage switch module 3. To transmit the credit information to be returned to the second-stage switch module 2 for the next scheduled data packet destined to the second-stage switch module 2 the credit information is added e.g. into the header and transferred to the second-stage switch module 2 having the number 4. There, the credit information is extracted from the received data packet and the transmitted credit is added to the credit memory, thereby resulting in an increase of the available credits in the respective second-stage switch module 2.

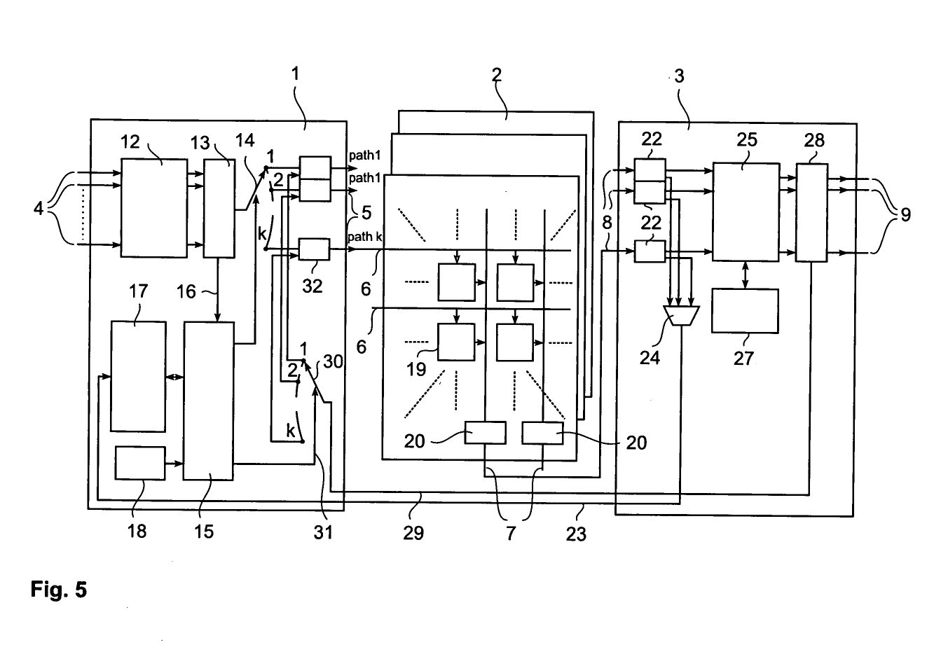

In FIG. 5, a switching device having the first-stage switch module 1, the second-stage switch modules 2 and the third-stage switch modules 3 are shown, which are interconnected in the above-described manner. It shows a part of a switching device topology shown in FIG. 1 wherein only one of the first-stage switch modules 1 and the associated one of the third-stage switch modules 3 is depicted and wherein each of the second-stage switch modules are depicted and interconnected via the different data paths 1 . . . k. A data packet received via one of the first inputs 4 is provided to a first data buffer 12 included in each of the first-stage switch modules 1. The first data buffers in the first stage may be a shared memory of multiple physical memories realizing overall multiple logical data packet buffers organized e.g. per pair of input/output (also referred to as cross point queues) or per output or final destination (also referred to as virtual output queues).

The received and temporarily buffered data packet is forwarded to a first packet scheduling means 13 from where the received data packets are transferred to a first controllable switching means 14 which connects the first packet scheduling means 13 with a selected data path wherein the respective data path is selected by a first control signal via a first select control line 16 from a path selection unit 15. The path selection unit 15 is connected to a first credit memory 17 in which the available data buffer locations of each of the second-stage switch modules 2 are stored continuously so that the credit information in the first credit memory 17 is permanently updated.

If two or more second-stage switch modules having the same number of available credits left, this may result in an unclear decision on what data path the data packet should be transmitted i.e. which of the second-stage switch modules 2 should be selected, the decision is made by a round-robin counter 18 which is also connected to the path selecting unit 15. The round-robin counter 18 determines a second-stage switch module 2 to select if the same number of credits is available. It works on a one-after-the-other basis. Each of the second-stage switch modules 2 substantially includes second data packet buffers 19 to store and to output data packets previously stored. A data packet received via a data path is normally stored in a free data buffer location and sent via one of the second outputs controlled by a second packet scheduling means 20 to the destined third-stage switch module 3. Each of the second-stage switch modules 2 is connected to the shown third-stage switch module 3 via a respective third input 8. The second-stage switch modules 2 contain second data buffers 19 for data packet buffering that is organized logically or physically per pair of input/output that is in cross point queues.

In order to provide the first-stage switch module 1 with the credit information from each of the second-stage switch modules 2 available indicating data buffer locations, a credit extraction unit 22 for each of the third input 8 of the third-stage switch module 3 are provided. The credit extraction unit 22 extracts the credit information sent by the second-stage switch modules 2 and provides the credit information over a first data line 23 to the credit memory 17 of the first-stage switch module 1. To reduce the number of first data lines 23 to the first-stage switch module, a demultiplexer 24 is connected to each of the credit extraction unit 23 to serialize the credit information for the credit memory 17. By providing the first data line 23 between the third-stage switch module 3 and the first-stage switch module 1, a data line between each of the second-stage switch modules 2 and the first-stage switch modules 1 can be avoided. As the first-stage switch module 1 and the third-stage switch module 3 are typically integrated in a single device, the first data lines 23 can be easily implemented.

The load balancing function within the first-stage switch module is load dependent based on the occupancy of all second-stage cross point queues reachable from the considered first-stage switch module on the k data paths. The actual packet dispatching is located after the data packet buffers, so that the decision about the data path is made based on the most up-to-date load information. The number of credits available in the credit memory of the first-stage switch module 1 for all k data buffers of the k second-stage switch modules 2 on each of the k data paths serve as load information. Based on a suitable packet scheduling algorithm (e.g. FIFO, round-robin with priorities) a packet scheduler chooses from the packet buffers a next packet for tentative transmission as if there was only one path. The destination address DA of the scheduled packet is handed over to the path selection unit 15 which searches for which path most credits are available in the credit memory for the second data buffers leading to the destination address. If at least one credit is found and if the path with the most credits found is not yet marked as occupied by another packet, the data packet is assigned to the found path by setting the first controllable switching means 14, so that the scheduled packet can proceed onto the found path. The found path is then marked as occupied and the associated credit is taken from the credit memory. The described process is then repeated sequentially or in parallel until data packets are eventually assigned to all data paths (i.e. all paths are marked as occupied) or until no more packets are available.

Since it may often happen that more than one data path has the same load, a randomization mechanism must be overlaid so that in this situation not always the same lowest load path is chosen. In particular, the randomization mechanism may be provided by the round-robin counter 18 that is incremented once per packet cycle and indicates to the path selection unit 15 at which data path to start searching for the lowest load path. This is important as typical search mechanisms would find the first or last lowest load path in the search sequence. By starting the search every time at another data path, the first or last found path would not always be the same one during periods without any change of the load situation.

After the credit information is extracted in the credit extraction unit 22 of the third-stage switch module 3, the respective data packets are transmitted to the third data packet buffer 25 from where the data packets are to be output via the outputs 9 of the third-stage switch module 3. The outputting of the data packets is done using a re-sequencing unit 27 initiating that the data packets are output on a respective output 9 in a predetermined order. In the data packet buffer, the packets are stored at least as long as the packets are not yet in sequence. Once they are in sequence, they may continue to wait in the data packet buffer for the purpose of pure output queuing that is waiting for being scheduled for transmission via the outputs 9 of the switching device. In the third-stage switch module 3, a third packet scheduling means 28 is provided for scheduling the transmission of the data packets out of the switching device.

At the output side, the path joining in a considered third-stage switch module 3 may be based on a round-robin credit return mechanism or alternatively a load dependent credit return mechanism based on the loads of all second-stage switch modules. In any case, it is preferred that the corresponding credit return logic is physically located in the associated first-stage switch module 1 in this embodiment. Every time the third packet scheduling means 28 sends out a data packet, a credit becomes free in the third-stage switch module 3, i.e. if the third packet scheduling means 28 has chosen a data packet from the third data packet buffer 25 for transmission to any of the third outputs 9. The credit associated with the freed data buffer location must be returned to one of the second-stage switch modules 2 in such a way that all of the second-stage switch modules 2 are served fair and in a balanced way over time.

To return a credit to the respective second-stage switch module 2, the credit is first handed over from the considered third-stage switch module 3 to the associated first-stage switch module via a second data line 29 that is explicitly provided for this purpose. The second data line 29 is typically an onboard or even on-chip circuit since both the third and the first-stage switch modules 3, 1 are assumed to be packaged together in one physical unit. The credit arriving in the first-stage switch module 1 is then inserted into a currently transmitted data packet on the respective data path that is determined by the setting of a second switching means 30 in the first-stage switch module 1. The setting of this second switching means is determined by a second select control signal sent via second control line 31. The second control signal is generated by the path selection unit 15 that might be the same unit as the one used for the load balancing. The path selection unit 15 in this case might be based on a simple round-robin mechanism or alternatively on a load dependent mechanism. In the former case, a round robin counter controls the second switching means 30. In the latter case, the path selection unit 15 may have a second functionality to search for the data path with the fewest credits available in the direction of the destination address. In the latter case, in order to avoid that the data path found by this second function is always the same one when the loading is the same and to ensure that all data paths get the same amount of credits under low load, a randomization mechanism must also be overlaid so that in this situation not always the same highest load path is chosen. The same kind of round-robin counter mechanism may be used for this purpose as in the data path selecting function for the input side. The round-robin counter 18 indicates to the data path selecting function at which data path to start searching for the highest load path.

The second data line 29 is connected via the second switching means 30 with credit insertion means 32 inserted into the data paths between the first switching means 14 and the outputs of the first stage switch modules 1. The credit insertion means is provided for each of the data paths so that the next data packet sent on the respective data path is provided with a credit sent via the second data line 29 destined for the respective second-stage switch module 2 located at the respective data path on which the credit information means includes the credit information.

In the case that multiple priority data packets must be supported, the scheduling means 20 of the second-stage switch module must support the priority rules. However, in order to reduce the priority blocking problem described above, the scheduling means 20 contains means to override the strict priority rules by using one or more multiple timers/counters which can cause lower priority packets to be served when these are waiting for more than one time-out period and when they are blocked by high priority traffic. Alternatively, but more complex, the priority overriding can be triggered by specific messages that might be generated by the re-sequencing unit 27 of the third-stage switch module 3 and sent like credits via packets to the scheduling means 20 of the second-stage switch modules. These messages might be generated when sequence gaps either of large size and of lengthy time period are detected in the re-sequencing unit 27. Their purpose is to fetch the data packet that would fill the sequence gaps.

The occurrence of a multiple priority problem in the third data buffer 28 is detected by the re-sequencing unit 27. The re-sequencing unit 27 can use the second data line 29 to transmit the message to the respective second-stage switch module 2 indicating that the priority rules should be overridden so that a lower priority data packet, which is blocked by the priority rules, is immediately sent to the respective third-stage switch module 3. The message is sent if the lower priority data packets are blocked for too long. This can be realized by a mechanism that takes into account the time a packet has spent in the queue. This could for example be a timer mechanism or any other priority adaptation mechanism.

Using a switching device according to the present invention and/or the method for forwarding a data packet according to the present invention load asymmetries can be minimized as both the credit-based load-dependent load balancing method and the credit return strategy provide an equalization of the available credits, i.e. an equalization of the available data packet buffer space in the second-stage switch modules 2. Thereby, the probability of backpressure is reduced. By maintaining the symmetry of the load it is easier to achieve a continuous data packet flow through the switching device retaining the order of receipt.

Although advantageous embodiments of the present invention have been described in detail, it should be understood that various changes, substitutions and alternations can be made therein without departing from spirit and scope of the inventions as defined by the appended claims.

1. A method for controlling a data packet flow through a switching device comprising a first number of first stage switch modules, a second number of second stage switch modules and a third number of third stage switch modules, each of the switch modules, having a number of data inputs a number of data outputs and a data packet buffer the data outputs of the first stage switch modules being connected to the data inputs of the second stage switch modules and the data outputs of the second stage switch modules to the data inputs of the third stage switch modules; wherein a data packet received at a data input of one of the first stage switch modules is forwarded to a specific data output of one of the third stage switch modules; the method comprising the steps of:
storing credit information associated to each of the second stage switch modules indicating a number of free data packet buffer locations in the respective second stage switch module;
selecting one of the second stage switch modules in dependence on the credit information;
forwarding the received data packet from the first stage switch module to the selected second stage switch module;
forwarding the received data packet from the selected second stage switch module to the respective third stage switch module, from which the received data packet is to be sent;
after sending the data packet from the respective third stage switch module, delivering a credit information about the freed data packet buffer location from the third stage switch module to the second stage switch module, wherein the respective second stage switch module is selected according to a credit return strategy.

2. A method according to claim 1, wherein according to the credit return strategy the respective second stage switch module is selected as the one having the most free data packet buffer locations.

3. A method according to claim 2, wherein the respective second stage switch module having the same number of free data packet buffer locations is selected randomly or according to a round-robin scheme.

4. A method according to claim 1, wherein according to the credit return strategy the credit is returned by increasing the number of free third-stage data packet buffer locations in the respective second stage switch module, wherein the respective second stage switch module is chosen by one of a round-robin scheme, by random, and by the second stage switch module having the lowest number of free data packet buffer locations.

5. A method according to claim 1, wherein the delivering of one credit information about the freed data packet buffer location from the third stage switch module to the second stage switch module includes the steps of:
transmitting the credit information from the third stage switch module to the first stage switch module;
adding the credit information to a next data packet to be transmitted to the chosen second stage switch module; and
transmitting the next data packet including the credit information to the chosen second stage switch module.

6. A method according to claim 1, further comprising the steps of:
forwarding the data packets according to a priority scheduling mechanism, wherein transmission of high-priority data packets are preferred to transmission of lower-priority data packets;
overriding the priority scheduling mechanism if the transmission of lower-priority data packets is blocked for a predetermined time or if an override information is generated indicating that one or more of the lower-priority data packet are preferably transmitted, wherein the override information is generated depending on missing low priority data packets in a sequence of data packets in the data buffer of the third stage switch module.

7. A first stage switch module of a three or more stage switching device comprising:
a number of data inputs;
a number of data outputs to be connected to second stage switch modules;
a data packet buffer to receive and to store externally received data packets;
a credit memory to store a first credit information for each of the second stage switch modules, wherein the credit memory has an input to receive an information about a freed data packet buffer location in one of the second stage switch modules;
a packet scheduling means to select the data output, on which a received data packet is to be sent, depending on the stored credit information of each of the second stage switch modules connected to the data outputs;
a credit insertion means to insert one or more credits in a data packet to be sent to a chosen second stage switch module associated with a respective data output to return the one or more credits according to a second credit information to the chosen second stage switch module wherein the second stage switch module is chosen by the packet scheduling means according to an appropriate credit return strategy.

8. A third stage switch module comprising:
a number of data inputs to be connected to second stage switch modules;
a number of data outputs;
a data packet buffer to receive and to store data packets from the second stage switch modules;
a credit extraction means to extract first credit information sent by the second stage switch modules and to provide the respective credit information used for a path selecting function which is operable to select a path for a data packet between a first stage switch module and a second stage switch module;
a packet scheduling means to send data packets to the respective data output in a given order and according to their destination and to return a credit information to one of the second stage switch modules.

9. A switching module comprising:
a first stage switch module according to claim 7,
and a third stage switch module, the third stage switch module comprising
a number of data inputs to be connected to second stage switch modules;
a number of data outputs;
a data packet buffer to receive and to store data packets from the second stage switch modules;
a credit extraction means to extract first credit information sent by the second stage switch modules and to provide the respective credit information used for a path selecting function which is operable to select a path for a data packet between a first stage switch module and a second stage switch module;
a packet scheduling means to send data packets to the respective data output in a given order and according to their destination and to return a credit information to one of the second stage switch modules,
wherein the first stage switch module and the third stage switch module are commonly integrated in one device, wherein at least one data line is provided to transmit credit information from the third-stage switch module to the first-stage switch module.

10. A switching device for controlling a data packet flow comprising
a first number of first stage switch modules according to claim 7;
a second number of second stage switch modules; and
a third number of third stage switch modules, each third stage switch module comprising:
a number of data inputs to be connected to second stage switch modules;
a number of data outputs;
a data packet buffer to receive and to store data packets from the second stage switch modules;
a credit extraction means to extract first credit information sent by the second stage switch modules and to provide the respective credit information used for a path selecting function which is operable to select a path for a data packet between a first stage switch module and a second stage switch module;
a packet scheduling means to send data packets to the respective data output in a given order and according to their destination and to return a credit information to one of the second stage switch modules;
each of the first, second, and third switch modules having a number of data inputs, a number of data outputs, and a data packet buffer, wherein the data outputs of the first stage switch modules are at least partially connected to the data inputs of the second stage switch modules, wherein the data outputs of the second stage switch modules are at least partially connected to the data inputs of the third stage switch modules,
wherein a data packet received at a data input of one of the first stage switch modules is forwarded to a specific data output of one of the third stage switch modules,
wherein the respective first credit information used for a path selecting function is provided to the credit memory of the first stage switch module to be stored,
wherein the respective second credit information is provided to the credit insertion means to insert in a data packet credit information of one or more credits to be sent to a chosen second stage switch module associated with a respective data output to return the one or more credits to the chosen second stage switch module according to the appropriate credit return strategy.

11. A switching device according to claim 10, wherein the second number of second-stage switch modules is bigger than the first number of first-stage switch modules.

12. A method according to claim 3,
wherein according to the credit return strategy the credit is returned by increasing the number of free third-stage data packet buffer locations in the respective second stage switch module, and
wherein the respective second stage switch module is chosen by one of a round-robin scheme, by random, and by the second stage switch module having the lowest number of free data packet buffer locations.

13. A method according to claim 4, wherein the delivering of one credit information about the freed data packet buffer location from the third stage switch module (3) to the second stage switch module includes the steps of:
transmitting the credit information from the third stage switch module to the first stage switch module;
adding the credit information to a next data packet to be transmitted to the chosen second stage switch module; and
transmitting the next data packet including the credit information to the chosen second stage switch module.
